(19) United States
(12) Patent Application Publication
(10) Pub. No.: US 2020/0374095 A1
(43) Pub. Date: Nov. 26, 2020

(54) RESOURCE CONFIGURATION METHOD AND DEVICE, AND COMPUTER STORAGE MEDIUM

(71) Applicant: GUANGDONG OPPO MOBILE TELECOMMUNICATIONS CORP., LTD., Dongguan (CN)

(72) Inventor: Jia SHEN, Dongguan (CN)

(73) Assignee: GUANGDONG OPPO MOBILE TELECOMMUNICATIONS CORP., LTD., Dongguan (CN)

(21) Appl. No.: 16/988,331

(22) Filed: Aug. 7, 2020

Related U.S. Application Data
(63) Continuation of application No. PCT/CN2018/075834, filed on Feb. 8, 2018.

(51) Int. Cl. H04L 5/00; H04W 72/04

(52) U.S. Cl. CPC H04L 5/0098; H04W 72/0453; H04W 72/0493; H04L 5/0092

(57) ABSTRACT

Provided are a resource configuration method and device, and a computer storage medium. The method includes that: a terminal receives first control information from a network device, the first control information including first indication information, and the first indication information being configured to determine at least two downlink (DL) band width parts (BWPs) to be activated or at least two uplink (UL) BWPs to be activated; and the terminal activates the at least two DL BWPs or the at least two UL BWPs according to the first control information.

### CROSS-REFERENCE TO RELATED APPLICATION

This application is a continuation of International Patent Application No. PCT/CN2018/075834 filed on Feb. 8, 2018, the contents of which are incorporated herein by reference in its entirety.

### TECHNICAL FIELD

The disclosure relates to the technical field of wireless communications, and in particular to a resource configuration method and device, and a computer storage medium.

### BACKGROUND

In a Long Term Evolution (LTE) system, a frequency domain resource of a terminal is allocated in a whole system bandwidth. As the system bandwidth is greatly increased in a 5th Generation (5G) New Radio (NR) system, a transmission bandwidth of the terminal may take up only a part of the system bandwidth.

### SUMMARY

A method for resource configuration according to a first aspect of the disclosure may include the following operations.

A terminal receives first control information from a network device, the first control information including first indication information, and the first indication information being configured to determine at least two downlink (DL) BWPs to be activated or at least two uplink (UL) BWPs to be activated.

The terminal activates the at least two DL BWPs or the at least two UL BWPs according to the first control information.

A method for resource configuration according to a second aspect of the disclosure may include the following operation.

A network device sends first control information to a terminal. The first control information may include first indication information, and the first indication information may be configured to determine at least two DL BWPs or the at least two UL BWPs to be activated, to enable the terminal to activate the at least two DL BWPs or the at least two UL BWPs according to the first control information.

A device for resource configuration according to a third aspect of the disclosure includes: a processor; and a transmission device connected to the processor and configured to receive and send information under control of the processor.

The transmission device is configured to receive first control information from a network device, the first control information including first indication information, and the first indication information being configured to determine at least two DL BWPs or the at least two UL BWPs to be activated.

The processor is configured to activate the at least two DL BWPs or the at least two UL BWPs according to the first control information.

A device for resource configuration according to a fourth aspect of the disclosure includes a processor, and a transmission device connected to the processor and configured to receive and send information under control of the processor.

The transmission device is configured to send first control information to a terminal, the first control information including first indication information, and the first indication information being configured to determine at least two DL BWPs or the at least two UL BWPs to be activated, to enable the terminal to activate the at least two DL BWPs or the at least two UL BWPs according to the first control information.

A computer storage medium provided by a fifth aspect of the disclosure has computer executable instructions stored thereon; and the computer executable instructions may implement, when being executed by a processor, the above-mentioned method for resource configuration.

### BRIEF DESCRIPTION OF THE DRAWINGS

The accompanying drawings are described here to provide a further understanding of the disclosure, and form a part of the disclosure. The schematic embodiments and description of the disclosure are adopted to explain the disclosure, and do not form improper limits to the disclosure. In the drawings:

FIG. 1 is a schematic diagram showing that only one BWP can be in an activated status.

FIG. 2 is a first flowchart of a resource configuration method according to embodiments of the disclosure.

FIG. 3 is a second flowchart of a resource configuration method according to embodiments of the disclosure.

FIG. 4 is a schematic diagram showing that BWPs in a BWP set are deactivated simultaneously in embodiments of the disclosure.

FIG. 5 is a schematic diagram showing that BWPs in a BWP set are deactivated respectively in embodiments of the disclosure.

FIG. 6 is a schematic diagram showing that BWPs in a BWP set have same frequency domain position and bandwidth size in embodiments of the disclosure.

FIG. 7 is a schematic diagram showing that frequency domain ranges of BWP₂, . . . , BWP_{N} are within a frequency domain range of BWP₁ in a BWP set in embodiments of the disclosure.

FIG. 8 is a schematic diagram showing that BWPs having same frequency domain position and bandwidth size are deactivated simultaneously in embodiments of the disclosure.

FIG. 9 is a schematic diagram showing that when timer 1 for DL BWP1 expires, the DL BWP1 and DL BWP2 within a frequency domain range of the DL BWP1 are deactivated simultaneously in embodiments of the disclosure.

FIG. 10 is a schematic diagram showing that BWP2 is deactivated earlier than BWP1 in embodiments of the disclosure.

FIG. 11 is a schematic diagram showing that BWP2 is deactivated earlier than BWP1 in embodiments of the disclosure.

FIG. 12 is a first structural diagram of a resource configuration device according to embodiments of the disclosure.

FIG. 13 is a second structural diagram of a resource configuration device according to embodiments of the disclosure.

FIG. 14 is a structural diagram of a computer device according to embodiments of the disclosure.

### DETAILED DESCRIPTION

In current research on 5G NR, a concept of a band width part (BWP) has been determined to be introduced to implement the allocation of the frequency domain resource within a range smaller than the system bandwidth. A base station may configure a plurality of BWPs via Radio Resource Control (RRC) signaling, and then dynamically activate a BWP via DL Control Information (DCI). A BWP is based on a parameter set. The parameter set includes a subcarrier interval and a Cyclic Prefix (CP). According to current solutions, only one BWP can be activated for one terminal; and when a new BWP is activated, the previous BWP may be deactivated.

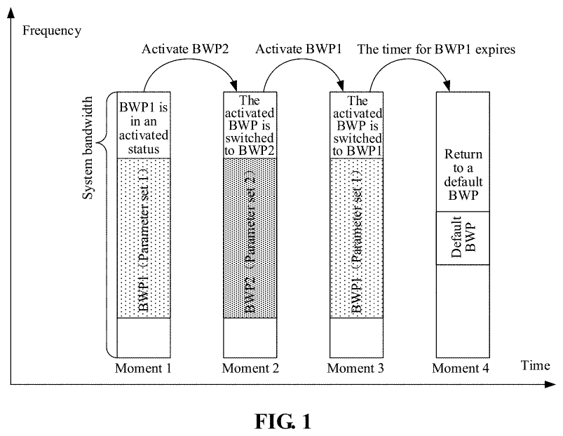

As shown in FIG. 1, when BWP1 is in an activated status, if BWP2 is activated, then the BWP1 may change to be deactivated; and when the BWP1 is deactivated, it may return to a default BWP.

According to the existing technical solutions, a plurality of BWPs cannot be activated simultaneously, that is, a plurality of parameter sets cannot be used simultaneously, and when a plurality of types of services are transmitted concurrently, parameters sets of different services cannot be optimized respectively. Moreover, switchover between two parameter sets may also lead to switchover between two BWPs and conversion of a Radio Frequency (RF) bandwidth of a terminal. Due to the conversion of the RF bandwidth, the terminal cannot receive or send data within a period of time and thus a waste of a spectrum resource may be caused.

For making the characteristics and technical contents of the disclosure understood in more detail, implementation of the embodiments of the disclosure will be described below in combination with the drawings in detail. The drawings are only adopted for description as references and not intended to limit the embodiments of the disclosure.

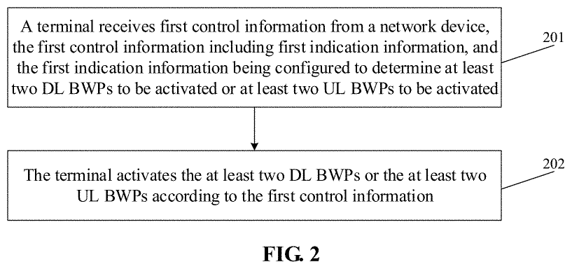

FIG. 2 is a first flowchart of a resource configuration method according to embodiments of the disclosure. As shown in FIG. 2, the resource configuration method includes the following operations.

At operation 201: a terminal receives first control information from a network device, the first control information including first indication information, and the first indication information being configured to determine at least two DL BWPs to be activated or at least two UL BWPs to be activated.

In some embodiments of the disclosure, the terminal may be any device capable of communicating with a network, such as a mobile phone, a tablet computer, a notebook and a desktop computer.

In some embodiments of the disclosure, the network device may be a base station, such as a gNB in a 5G system.

In some embodiments of the disclosure, the first control information may be DCI or a Media Access Control Control Element (MAC CE).

At operation 202: the terminal activates the at least two DL BWPs or the at least two UL BWPs according to the first control information.

In some embodiments of the disclosure, the terminal may receive first configuration information from the network device. The first configuration information may include configuration information of at least one DL BWP set or at least one UL BWP set, the DL BWP set may include a plurality of DL BWPs, and the UL BWP set may include a plurality of UL BWPs.

Herein, the configuration information of the BWP set may include a BWP identifier (ID), a frequency domain position, a bandwidth size and a parameter set of each BWP included in the BWP set. The parameter set may include a subcarrier interval and a Cyclic Prefix (CP).

In some embodiments of the disclosure, the first configuration information may be RRC signaling or System Information (SI).

In some embodiments of the disclosure, the operation that the terminal activates the at least two DL BWPs or the at least two UL BWPs according to the first control information may be implemented via the following manners.

Manner 1: in response to that the first indication information is indication information of a first BWP set, the terminal may activate each BWP in the first BWP set. In a case that the first BWP set is the DL BWP set, each BWP in the first BWP set is the DL BWP; or in a case that the first BWP set is the UL BWP set, each BWP in the first BWP set is the UL BWP.

For example, the first configuration information may include configuration information of a first BWP set for downlink or uplink. The first BWP set may include BWP₁, . . . , BWP_{N} (N≥2). Upon reception of the first control information including the indication information of the first BWP set, the terminal may activate BWP₁, . . . , BWP_{N}. The BWP₁, . . . , BWP_{N} may be DL activated BWPs or UL activated BWPs.

In an implementation, the method may further include that: the terminal receives second configuration information from the network device, the second configuration information including first duration information corresponding to the first BWP set; and the terminal deactivates each BWP in the first BWP set in response to that an activated duration of each BWP in the first BWP set reaches a first duration.

For example, the terminal may receive the second configuration information from the network device. The second configuration information may include information of a timer for the first BWP set (set_timer); and after the set_timer expires, the BWP₁, . . . , BWP_{N} may be deactivated.

In an implementation, the method may further include that: the terminal receives third configuration information from the network device, the third configuration information including second duration information corresponding to a first BWP in the first BWP set; and the terminal deactivates the first BWP in response to that an activated duration of the first BWP reaches a second duration.

For example, the terminal may receive the third configuration information from the network device. The third configuration information may include information of a timer for BWPᵢ(i=1, . . . , N) (timerᵢ); and after the timeri expires, the BWPᵢ may be deactivated.

In an implementation, the method may further include that: in response to that each BWP in the first BWP set is deactivated, a default BWP is activated.

For example, in response to that the BWP₁, . . . , BWP_{N} in the first BWP set are all deactivated, the DL activated BWP or the UL activated BWP may be changed into the default BWP.

Manner 2: in response to determining, based on the first configuration information, that each BWP in a second BWP set meets a predetermined rule and the first indication information is indication information of a second BWP in the second BWP set, the terminal activates each BWP in the second BWP set. In a case that the second BWP set is the DL BWP set, each BWP in the second BWP set is the DL BWP; or in a case that the second BWP set is the UL BWP set, each BWP in the second BWP set is the UL BWP.

For example, the first configuration information may include configuration information of the second BWP set for downlink or uplink. The second BWP set may include BWP₁, . . . , BWP_{N} (N≥2). In a case that the BWP₁, . . . , BWP_{N} (N≥2) in the second BWP set meet the predetermined rule, upon the reception of the first control information including the indication information of the BWP1, the terminal may activate the BWP₁, . . . , BWP_{N}. The BWP₁, . . . , BWP_{N} may be DL activated BWPs or UL activated BWPs.

In an implementation, the method may further include that: the terminal activates the second BWP in response to determining, based on the first configuration information, that each BWP in the second BWP set does not meet the predetermined rule and the first indication information is indication information of the second BWP in the second BWP set. In a case that the second BWP set is the DL BWP set, the second BWP is the DL BWP; or in a case that the second BWP set is the UL BWP set, the second BWP is the UL BWP.

For example, in a case that the BWP₁, . . . , BWP_{N} (N≥2) in the configured second BWP set do not meet the predetermined rule, after the terminal receives the first control information including the indication information of the BWP₁, the BWP₁ may become the DL activated BWP or the UL activated BWP.

In some embodiments of the disclosure, each BWP in the second BWP set meets the predetermined rule, which may include at least one of the following situations.

1) Each BWP in the second BWP set is consistent in frequency domain position and bandwidth size.

For example, the BWP₁, . . . , BWP_{N} may be consistent in frequency domain position and bandwidth size.

2) A frequency domain range of each BWP, other than the second BWP, in the second BWP set is within a frequency domain range of the second BWP.

For example, the frequency domain ranges of the BWP₂, . . . , BWP_{N} may be within the frequency domain range of the BWP₁.

3) An RF bandwidth capacity of the terminal is capable of simultaneously covering a frequency domain range of each BWP in the second BWP set.

For example, the RF bandwidth capacity of the terminal can simultaneously cover the frequency domain ranges of the BWP₁, . . . , BWP_{N}.

In an implementation, the method may further include that: the terminal receives fourth configuration information from the network device, the fourth configuration information including third duration information corresponding to the second BWP; and the terminal deactivates each BWP in the second BWP set in response to that an activated duration of the second BWP reaches a third duration.

For example, in response to that the timer for the BWP₁ (timer₁) expires, the BWP₁, . . . , BWP_{N} may be deactivated.

In an implementation, the method may further include that: the terminal receives fifth configuration information from the network device, the fifth configuration information including fourth duration information corresponding to a third BWP in the second BWP set; and the terminal deactivates the third BWP in response to that an activated duration of the third BWP reaches a fourth duration, the third BWP being different from the second BWP.

For example, in response to that the timer for the BWPᵢ (i=2, . . . , N) expires, the BWPᵢ may be deactivated.

In an implementation, the method may further include that: in response to that each BWP in the second BWP set is deactivated, a default BWP may be activated.

For example, in response to that the BWP₁, . . . , BWP_{N} in the second BWP set are all deactivated, the DL activated BWP or the UL activated BWP may be changed into the default BWP.

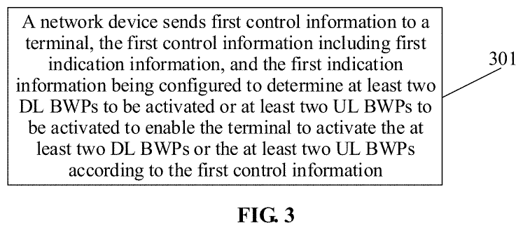

FIG. 3 is a second flowchart of a resource configuration method according to embodiments of the disclosure. As shown in FIG. 3, the resource configuration method includes the following operation.

At operation 301: a network device sends first control information to a terminal, the first control information including first indication information, and the first indication information being configured to determine at least two DL BWPs to be activated or the at least two UL BWPs to be activated, to enable the terminal to activate the at least two DL BWPs or the at least two UL BWPs according to the first control information.

In an implementation, the method may further include that: the network device sends first configuration information to the terminal, the first configuration information including configuration information of at least one DL BWP set or at least one UL BWP set, the DL BWP set including a plurality of DL BWPs, and the UL BWP set including a plurality of UL BWPs.

In some embodiments of the disclosure, the first indication information may be configured to determine the at least two DL BWPs or the at least two UL BWPs to be activated, which may be implemented via the following manners.

Manner 1: in response to that the first indication information is indication information of a first BWP set, the first indication information is configured to enable the terminal to activate each BWP in the first BWP set. In a case that the first BWP set is the DL BWP set, each BWP in the first BWP set is the DL BWP; or in a case that the first BWP set is the UL BWP set, each BWP in the first BWP set is the UL BWP.

In an implementation, the method may further include that: the network device sends second configuration information to the terminal, the second configuration information including first duration information corresponding to the first BWP set. The first duration information may be configured to enable, in response to that an activated duration of each BWP in the first BWP set reaches a first duration, the terminal to deactivate each BWP in the first BWP set.

In an implementation, the method may further include that: the network device sends third configuration information to the terminal, the third configuration information including second duration information corresponding to a first BWP in the first BWP set. The second duration information may be configured to enable, in response to that an activated duration of the first BWP reaches a second duration, the terminal to deactivate the first BWP.

Manner 2: in response to it is determined, based on the first configuration information, that each BWP in a second BWP set meets a predetermined rule and the first indication information is indication information of a second BWP in the second BWP set, the first indication information may be configured to enable the terminal to activate each BWP in the second BWP set. In a case that the second BWP set is the DL BWP set, each BWP in the second BWP set is the DL BWP; or in a case that the second BWP set is the UL BWP set, each BWP in the second BWP set is the UL BWP.

In an implementation, in response to it is determined, based on the first configuration information, that each BWP in the second BWP set does not meet the predetermined rule and the first indication information is indication information of the second BWP in the second BWP set, the first indication information may be configured to enable the terminal to activate the second BWP. In a case that the second BWP set is the DL BWP set, the second BWP is the DL BWP; or in a case that the second BWP set is the UL BWP set, the second BWP is the UL BWP.

In an implementation, each BWP in the second BWP set meets the predetermined rule, which may include the following situations:

each BWP in the second BWP set is consistent in frequency domain position and bandwidth size; or

a frequency domain range of each BWP, other than the second BWP, in the second BWP set is within a frequency domain range of the second BWP; or

an RF bandwidth capacity of the terminal can simultaneously cover a frequency domain range of each BWP in the second BWP set.

In an implementation, the method may further include that: the network device sends fourth configuration information to the terminal, the fourth configuration information including third duration information corresponding to the second BWP. The third duration information may be configured to enable, in response to that an activated duration of the second BWP reaches a third duration, the terminal to deactivate each BWP in the second BWP set.

In an implementation, the method may further include that: the network device sends fifth configuration information to the terminal, the fifth configuration information including fourth duration information corresponding to a third BWP in the second BWP set. The fourth duration information may be configured to enable, in response to that an activated duration of the third BWP reaches a fourth duration, the terminal to deactivate the third BWP, the third BWP being different from the second BWP.

The technical solutions of the disclosure are further described below in combination with specific application examples.

### Example 1: Configuration and Activation of a BWP Set

As shown in Table 1 and Table 2, the first configuration information is configured with 4 DL BWP sets and 2 UL BWP sets which includes the 4 DL BWPs respectively. The DL BWP set 1 includes DL BWP 1 and DL BWP 2, and the DL BWP set 2 includes DL BWP 3 and DL BWP 4. If the first control information includes an ID of the DL BWP set 1, then the DL BWP 1 and the DL BWP 2 may be activated simultaneously. If the first control information includes an ID of the DL BWP set 2, then the DL BWP 3 and the DL BWP 4 may be activated simultaneously.

TABLE 1
configuration of DL BWP

| | Frequency | | |
|---|---|---|---|
| DL BWP ID | domain position | Bandwidth size | Parameter set |
| DL BWP 1 | Frequency domain | Bandwidth size 1 | Parameter set 1 |
| | position 1 | | |
| DL BWP 2 | Frequency domain | Bandwidth size 2 | Parameter set 2 |
| | position 2 | | |
| DL BWP 3 | Frequency domain | Bandwidth size 3 | Parameter set 3 |
| | position 3 | | |
| DL BWP 4 | Frequency domain | Bandwidth size 4 | Parameter set 4 |
| | position 4 | | |

TABLE 2
configuration of DL BWP set

| ID of DL BWP set | BWP included |
|---|---|
| DL BWP set 1 | DL BWP 1, DL BWP 2 |
| DL BWP set 2 | DL BWP 3, DL BWP 4 |

Another method for achieving the same effect is as shown in Table 3, that is, two DL BWP sets are configured, and BWPs included in each BWP set are configured.

TABLE 3
configuration of DL BWP set and DL BWP

| ID of DL | | Frequency | Bandwidth | Parameter |
|---|---|---|---|---|
| BWP set | DL BWP ID | domain position | size | set |
| DL BWP | DL BWP 1 | Frequency | Bandwidth | Parameter |
| set 1 | | domain position 1 | size 1 | set 1 |
| | DL BWP 2 | Frequency | Bandwidth | Parameter |
| | | domain position 2 | size 2 | set 2 |
| DL BWP | DL BWP 3 | Frequency | Bandwidth | Parameter |
| set 2 | | domain position 3 | size 3 | set 3 |
| | DL BWP 4 | Frequency | Bandwidth | Parameter |
| | | domain position 4 | size 4 | set 4 |

It is to be understood that the configuration and activation methods of the UL BWP set is the same as those of the DL BWP set.

### Example 2: Simultaneous Deactivation of BWPs in a BWP Set

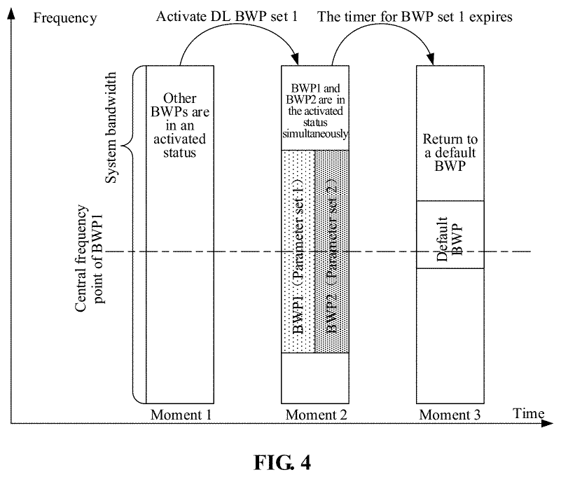

As shown in FIG. 4, when the DL BWP1 and the DL BWP2 belonging to the DL BWP set 1 are in an activated status, and when a timer for the DL BWP set 1 expires, the DL BWP1 and the DL BWP2 can be deactivated simultaneously.

It is to be understood that the configuration and activation methods of the UL BWP set is the same as those of the DL BWP set.

### Example 3: Respective Deactivation of BWPs in a BWP Set

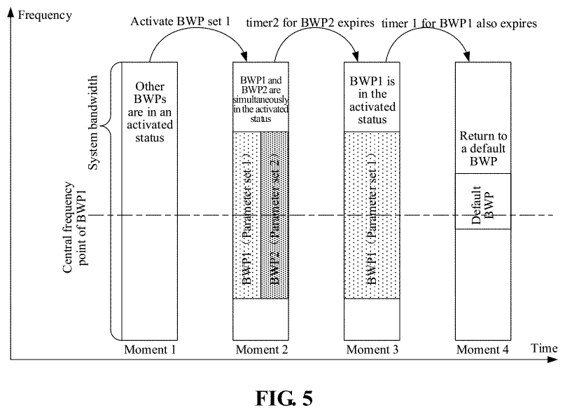

As shown in FIG. 5, when the DL BWP1 and the DL BWP2 belonging to the DL BWP set 1 are in an activated status and when a timer1 for the DL BWP2 expires, the DL BWP 2 may be deactivated; and when a timer2 for the DL BWP1 expires, the DL BWP 1 may be also deactivated.

It is to be understood that the configuration and activation methods of the UL BWP set is the same as those of the DL BWP set.

### Example 4: Configuration and Activation of a BWP Set

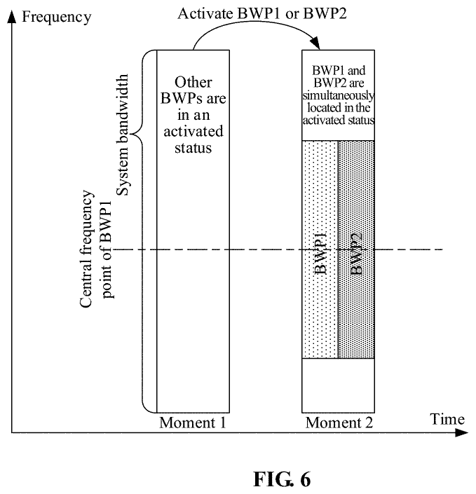

A first predetermined rule is shown in Table 4 and FIG. 6, that is, each BWP in one BWP set has the same frequency domain position and bandwidth size. The first configuration information is configured with 4 DL BWPs. The DL BWP 1 and the DL BWP 2 are consistent in frequency domain position and bandwidth size to form a DL BWP set. The DL BWP 3 and the DL BWP 4 are consistent in frequency domain position and bandwidth size to form another DL BWP set. In a case that the first control information includes an ID of the DL BWP1 or an ID of the DL BWP 2, the DL BWP 1 and the DL BWP 2 may be activated simultaneously. In a case that the first control information includes an ID of the DL BWP 3 or an ID of DL BWP 4, the DL BWP 3 and the DL BWP 4 may be activated simultaneously.

TABLE 4
BWPs included in a BWP set are consistent in
frequency domain position and bandwidth size

| ID of | Frequency domain | Bandwidth | Parameter |
|---|---|---|---|
| DL BWP | position | size | set |
| DL BWP 1 | Frequency domain | Bandwidth | Parameter |
| | position 1 | size 1 | set 1 |
| DL BWP 2 | Frequency domain | Bandwidth | Parameter |
| | position 1 | size 1 | set 2 |
| DL BWP 3 | Frequency domain | Bandwidth | Parameter |
| | position 2 | size 2 | set 1 |
| DL BWP 4 | Frequency domain | Bandwidth | Parameter |
| | position 2 | size 2 | set 2 |

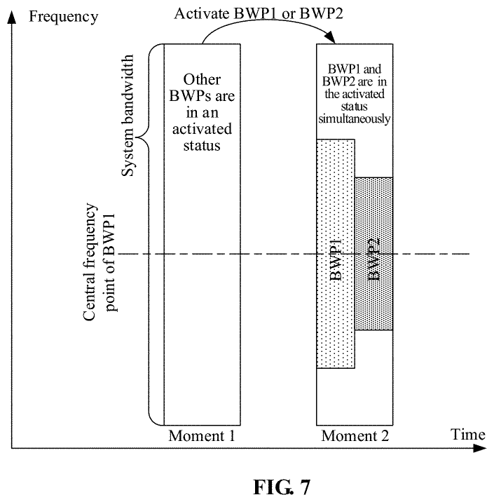

A second predetermined rule is shown in Table 5 and FIG. 7, that is, frequency domain ranges of BWP₂, . . . , BWP_{N} are within a frequency domain range of BWP₁ in one BWP set. The first configuration information is configured with 4 DL BWPs. The frequency domain range of the DL BWP 2 is within in the frequency domain range of the DL BWP 1. The DL BWP1 and the DL BWP 2 are formed into a DL BWP set. The frequency domain range of the DL BWP 4 is within in the frequency domain range of the DL BWP 3. The DL BWP3 and the DL BWP 4 are formed into another DL BWP set. In a case that the first control information includes an ID of the DL BWP1 or the DL BWP 2, the DL BWP 1 and the DL BWP 2 may be activated simultaneously. In a case that the first control information includes an ID of the DL BWP 3 or DL BWP 4, the DL BWP 3 and the DL BWP 4 may be activated simultaneously.

TABLE 5
frequency domain ranges of BWP₂, . . . , BWP_{N} are
within a frequency domain range of BWP₁ in a BWP set

| ID of | Frequency domain position | Parameter |
|---|---|---|
| DL BWP | and bandwidth size | set |
| DL BWP 1 | Frequency domain position 1 | Parameter |
| | and bandwidth size 1 | set 1 |
| DL BWP 2 | Frequency domain position 2 | Parameter |
| | and bandwidth size 2 | set 2 |
| | (The frequency domain range is | |
| | within the range of | |
| | the DL BWP 1) | |
| DL BWP 3 | Frequency domain position 3 | Parameter |
| | and bandwidth size 3 | set 1 |
| DL BWP 4 | Frequency domain position 4 | Parameter |
| | and bandwidth size 4 | set 2 |
| | (The frequency domain range is | |
| | within the range of | |
| | the DL BWP 3) | |

It is to be understood that the configuration and activation methods of the UL BWP set is the same as those of the DL BWP set.

### Example 5: Simultaneous Deactivation of BWPs in a BWP Set

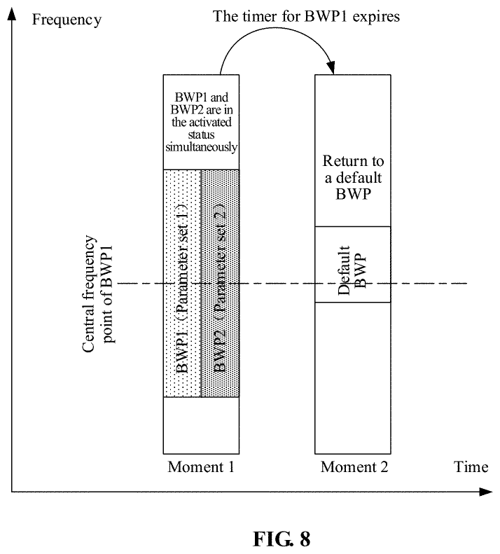

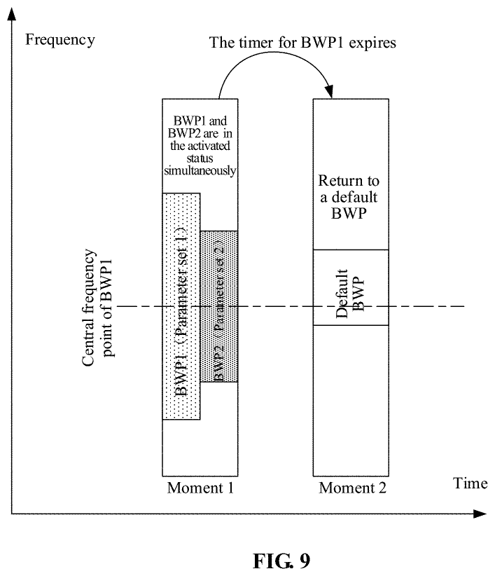

As shown in FIG. 8 and FIG. 9, when the DL BWP1 and the DL BWP2 are in an activated status simultaneously and the DL BWP1 and the DL BWP2 have the same frequency domain positions and bandwidth sizes or the frequency domain range of the DL BWP2 is within the frequency domain range of the DL BWP1, and after a timer1 for the DL BWP1 expires, the DL BWP1 and the DL BWP2 may be deactivated simultaneously.

It is to be understood that the configuration and activation methods of the UL BWP set is the same as those of the DL BWP set.

### Example 6: Respective Deactivation of BWPs in a BWP Set

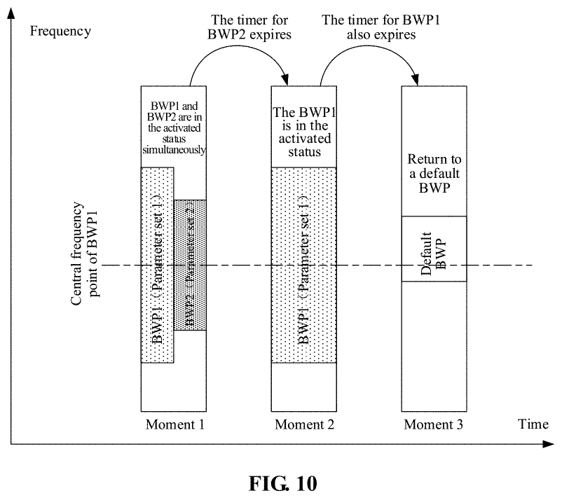

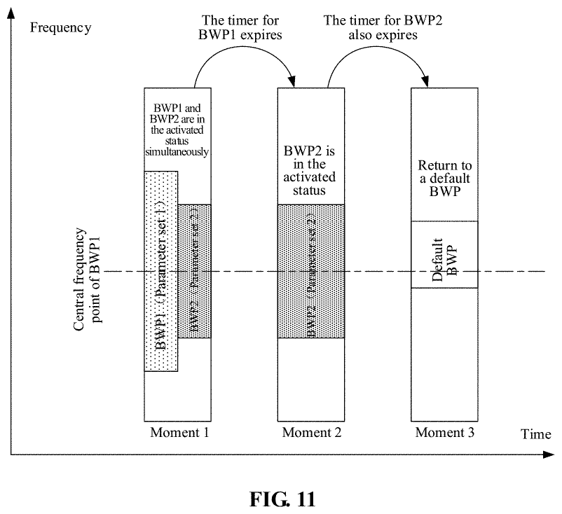

As shown in FIG. 10 and FIG. 11, when the DL BWP1 and the DL BWP2 are in an activated status simultaneously and when a timer1 for the DL BWP1 expires, the DL BWP1 may be deactivated and the DL BWP2 may be still in the activated status. When a timer2 for the DL BWP2 expires, the DL BWP2 may be deactivated and the DL BWP1 may be still in the activated status.

It is to be understood that the configuration and activation methods of the UL BWP set is the same as those of the DL BWP set.

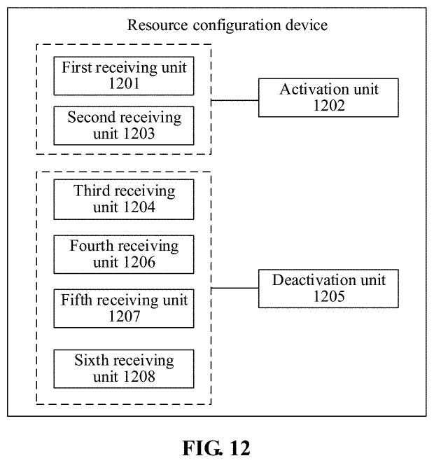

FIG. 12 is a first structural diagram of a resource configuration device according to embodiments of the disclosure. As shown in FIG. 12, the resource configuration device includes a first receiving unit 1201 and an activation unit 1202.

The first receiving unit 1201 is configured to receive first control information from a network device, the first control information including first indication information, and the first indication information being configured to determine at least two DL BWPs to be activated or at least two UL BWPs to be activated.

The activation unit 1202 is configured to activate the at least two DL BWPs or the at least two UL BWPs according to the first control information.

In an implementation, the device may further include a second receiving unit 1203.

The second receiving unit 1203 is configured to receive first configuration information from the network device, the first configuration information including configuration information of at least one DL BWP set or at least one UL BWP set, the DL BWP set including a plurality of DL BWPs, and the UL BWP set including a plurality of UL BWPs.

In an implementation, the activation unit 1202 is configured to enable, in response to that the first indication information is indication information of a first BWP set, a terminal to activate each BWP in the first BWP set.

In a case that the first BWP set is the DL BWP set, each BWP in the first BWP set may be the DL BWP; or in a case that the first BWP set is the UL BWP set, each BWP in the first BWP set may be the UL BWP.

In an implementation, the device may further include a third receiving unit 1204 and a deactivation unit 1205.

The third receiving unit 1204 is configured to receive second configuration information from the network device, the second configuration information including first duration information corresponding to the first BWP set.

The deactivation unit 1205 is configured to deactivate each BWP in the first BWP set in response to that an activated duration of each BWP in the first BWP set reaches a first duration.

In an implementation, the device may further include a fourth receiving unit 1206 and the deactivation unit 1205.

The fourth receiving unit 1206 is configured to receive third configuration information from the network device, the third configuration information including second duration information corresponding to a first BWP in the first BWP set.

The deactivation unit 1205 is configured to deactivate the first BWP in response to that an activated duration of the first BWP reaches a second duration.

In an implementation, the activation unit 1202 is further configured to activate a default BWP in response to that each BWP in the first BWP set is deactivated.

In an implementation, the activation unit 1202 is configured to activate each BWP in the second BWP set in response to determining, based on the first configuration information, that each BWP in a second BWP set meets a predetermined rule and the first indication information is indication information of a second BWP in the second BWP set.

In a case that the second BWP set is the DL BWP set, each BWP in the second BWP set may be the DL BWP; or in a case that the second BWP set is the UL BWP set, each BWP in the second BWP set may be the UL BWP.

In an implementation, the activation unit 1202 is configured to activate each BWP in the second BWP set in response to determining, based on the first configuration information, that each BWP in a second BWP set meets a predetermined rule and the first indication information is indication information of a second BWP in the second BWP set.

In a case that the second BWP set is the DL BWP set, the second BWP may be the DL BWP; or in a case that the second BWP set is the UL BWP set, the second BWP may be the UL BWP.

In an implementation, each BWP in the second BWP set meets the predetermined rule, which may include the following situations:

each BWP in the second BWP set is consistent in frequency domain position and bandwidth size; or

a frequency domain range of each BWP, other than the second BWP, in the second BWP set is within a frequency domain range of the second BWP; or

an RF bandwidth capacity of the terminal can simultaneously cover a frequency domain range of each BWP in the second BWP set.

In an implementation, the device may further include a fifth receiving unit 1207 and the deactivation unit 1205.

The fifth receiving unit 1207 is configured to receive fourth configuration information from the network device, the fourth configuration information including third duration information corresponding to the second BWP.

The deactivation unit 1205 is configured to deactivate each BWP in the second BWP set in response to that an activated duration of the second BWP reaches a third duration.

In an implementation, the device may further include a sixth receiving unit 1208 and the deactivation unit 1205.

The sixth receiving unit 1208 is configured to receive fifth configuration information from the network device, the fifth configuration information including fourth duration information corresponding to a third BWP in the second BWP set.

The deactivation unit 1205 is configured to deactivate the third BWP in response to that an activated duration of the third BWP reaches a fourth duration, the third BWP being different from the second BWP.

In an implementation, the activation unit 1202 is further configured to activate a default BWP in response to that each BWP in the second BWP set is deactivated.

Those skilled in the art should know that functions realized by each unit in the resource configuration device shown in FIG. 12 may be understood with reference to related descriptions about the resource configuration method. The functions of each unit in the resource configuration device shown in FIG. 12 may be realized through a program running in a processor, and may also be realized through a specific logical circuit.

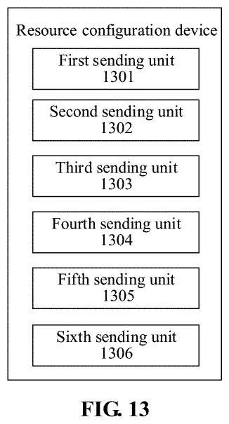

FIG. 13 is a second structural diagram of a resource configuration device according to embodiments of the disclosure. As shown in FIG. 13, the resource configuration device includes a first sending unit 1301.

The first sending unit 1301 is configured to send first control information to a terminal, the first control information including first indication information, and the first indication information being configured to determine at least two DL BWPs to be activated or at least two UL BWPs to be activated to enable the terminal to activate the at least two DL BWPs or the at least two UL BWPs according to the first control information.

In an implementation, the device may further include a second sending unit 1302.

The second sending unit 1302 is configured to send first configuration information to the terminal, the first configuration information including configuration information of at least one DL BWP set or at least one UL BWP set, the DL BWP set including a plurality of DL BWPs, and the UL BWP set including a plurality of UL BWPs.

In an implementation, in response to that the first indication information is indication information of a first BWP set, the first indication information may be configured to enable the terminal to activate each BWP in the first BWP set.

In a case that the first BWP set is the DL BWP set, each BWP in the first BWP set may be the DL BWP; or in a case that the first BWP set is the UL BWP set, each BWP in the first BWP set may be the UL BWP.

In an implementation, the device may further include a third sending unit 1303.

The third sending unit 1303 is configured to send second configuration information to the terminal, the second configuration information including first duration information corresponding to the first BWP set.

The first duration information is configured to enable, in response to that an activated duration of each BWP in the first BWP set reaches a first duration, the terminal to deactivate each BWP in the first BWP set.

In an implementation, the device may further include a fourth sending unit 1304.

The fourth sending unit 1304 is configured to send third configuration information to the terminal, the third configuration information including second duration information corresponding to a first BWP in the first BWP set.

The second duration information is configured to enable, in response to that an activated duration of the first BWP reaches a second duration, the terminal to deactivate the first BWP.

In an implementation, in response to it is determined, based on the first configuration information, that each BWP in a second BWP set meets a predetermined rule and the first indication information is indication information of a second BWP in the second BWP set, the first indication information is configured to enable the terminal to activate each BWP in the second BWP set.

In a case that the second BWP set is the DL BWP set, each BWP in the second BWP set may be the DL BWP; or in a case that the second BWP set is the UL BWP set, each BWP in the second BWP set may be the UL BWP.

In an implementation, in response to it is determined, based on the first configuration information, that each BWP in the second BWP set does not meet the predetermined rule and the first indication information is the indication information of the second BWP in the second BWP set, the first indication information is configured to enable the terminal to activate the second BWP.

In a case that the second BWP set is the DL BWP set, the second BWP may be the DL BWP; or in a case that the second BWP set is the UL BWP set, the second BWP may be the UL BWP.

In an implementation, each BWP in the second BWP set meets the predetermined rule, which may include the following situations:

each BWP in the second BWP set is consistent in frequency domain position and bandwidth size; or

a frequency domain range of each BWP, other than the second BWP, in the second BWP set is within a frequency domain range of the second BWP; or

an RF bandwidth capacity of the terminal can simultaneously cover a frequency domain range of each BWP in the second BWP set.

In an implementation, the device may further include a fifth sending unit 1305.

The fifth sending unit 1305 is configured to send fourth configuration information to the terminal, the fourth configuration information including third duration information corresponding to the second BWP.

The third duration information is configured to enable, in response to that an activated duration of the second BWP reaches a third duration, the terminal to deactivate each BWP in the second BWP set.

In an implementation, the device may further include a sixth sending unit 1306.

The sixth sending unit 1306 is configured to send fifth configuration information to the terminal, the fifth configuration information including fourth duration information corresponding to a third BWP in the second BWP set.

The fourth duration information is configured to enable, in response to that an activated duration of the third BWP reaches a fourth duration, the terminal to deactivate the third BWP, the third BWP being different from the second BWP.

Those skilled in the art should know that functions realized by each unit in the resource configuration device shown in FIG. 13 may be understood with reference to related descriptions about the resource configuration method. The functions of each unit in the resource configuration device shown in FIG. 13 may be realized through a program running in a processor, and may also be realized through a specific logical circuit.

When being implemented by software functional modules and sold or used as an independent product, the resource configuration devices of some embodiments of the disclosure may also be stored in a computer-readable storage medium. Based on such an understanding, the technical solutions of the disclosure substantially or the parts making contributions to the conventional art may be embodied as a software product. The computer software product is stored in a storage medium, including a plurality of instructions configured to enable a computer device (which may be a personal computer, a server, a network device or the like) to execute all or part of the method in each embodiment of the disclosure. The storage medium may include various media capable of storing program codes, such as a U disk, a mobile hard disk, a Read Only Memory (ROM), a magnetic disk or an optical disk. Therefore, the embodiments of the disclosure are not limited to any specific hardware and software combination.

Correspondingly, some embodiments of the disclosure further provide a computer storage medium, which has computer executable instructions stored thereon. The computer executable instructions may implement, when being executed by a processor, the above-mentioned resource configuration methods.

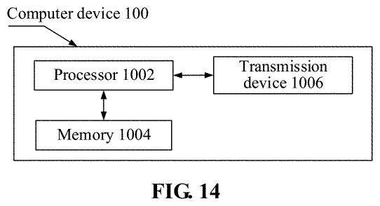

FIG. 14 is a structural diagram of a computer device according to embodiments of the disclosure. The computer device may be a terminal or may also be a network device. As shown in FIG. 14, the computer device 100 may include one or more (only one is illustrated in the figure) processors 1002 (the processor 1002 may include, but not limited to, a processing device such as a Micro Control Unit (MCU) or a Field Programmable Gate Array (FPGA)), a memory 1004 configured to store data and a transmission device 1006 configured for a communication function. Those of ordinary skill in the art should know that the structure shown in FIG. 14 is only schematic and not intended to limit the structure of the electronic device. For example, the computer device 100 may further include components more or fewer than the components shown in FIG. 14 or has a configuration different from that shown in FIG. 14.

The memory 1004 may be configured to store a software program of application software and a module, for example, a program instruction/module corresponding to a method in some embodiments of the disclosure. The processor 1002 runs the software program and module stored in the memory 1004, thereby executing various functional applications and data processing, namely implementing the above-mentioned method. The memory 1004 may be a high-speed random access memory or may be a nonvolatile memory, for example, one or more magnetic storage devices, flash memories or other nonvolatile solid-state memories. In some examples, the memory 1004 may further include a memory arranged remotely relative to the processor 1002 and the remote memory may be connected to the computer device 100 through a network. An example of the network includes, but not limited to, the Internet, an intranet, a local area network, a mobile communication network and a combination thereof.

The transmission device 1006 is configured to receive or send data through a network. A specific example of the network may include a wireless network provided by a communication provider of the computer device 100. In an example, the transmission device 1006 includes a Network Interface Controller (NIC), which may be connected with another network device through a base station, thereby communicating with the Internet. In an example, the transmission device 1006 may be a Radio Frequency (RF) module, configured to communicate with the Internet in a wireless manner.

As described above, a method for resource configuration according to a first aspect of the disclosure may include that:

a terminal receives first control information from a network device, the first control information including first indication information, and the first indication information being configured to determine at least two downlink (DL) BWPs to be activated or at least two uplink (UL) BWPs to be activated; and

the terminal activates the at least two DL BWPs or the at least two UL BWPs according to the first control information.

In some embodiments of the disclosure, the method may further include that:

the terminal receives first configuration information from the network device, the first configuration information including configuration information of at least one DL BWP set or at least one UL BWP set, the DL BWP set including a plurality of DL BWPs, and the UL BWP set including a plurality of UL BWPs.

In some embodiments of the disclosure, the operation that the terminal activates the at least two DL BWPs or the at least two UL BWPs according to the first control information may include that:

in response to that the first indication information is indication information of a first BWP set, the terminal activates each BWP in the first BWP.

In a case that the first BWP set is the DL BWP set, each BWP in the first BWP set is the DL BWP; or in a case that the first BWP set is the UL BWP set, each BWP in the first BWP set is the UL BWP.

In some embodiments of the disclosure, the method may further include that:

the terminal receives second configuration information from the network device, the second configuration information including first duration information corresponding to the first BWP set; and

the terminal deactivates each BWP in the first BWP set in response to that an activated duration of each BWP in the first BWP set reaches a first duration.

In some embodiments of the disclosure, the method may further include that:

the terminal receives third configuration information from the network device, the third configuration information including second duration information corresponding to a first BWP in the first BWP set; and

the terminal deactivates the first BWP in response to that an activated duration of the first BWP reaches a second duration.

In some embodiments of the disclosure, the method may further include that:

a default BWP is activated in response to that each BWP in the first BWP set is deactivated.

In some embodiments of the disclosure, the operation that the terminal activates the at least two DL BWPs or the at least two UL BWPs according to the first control information may include that:

in response to determining, based on the first configuration information, that each BWP in a second BWP set meets a predetermined rule and the first indication information is indication information of a second BWP in the second BWP set, the terminal activates each BWP in the second BWP set.

In a case that the second BWP set is the DL BWP set, each BWP in the second BWP set is the DL BWP; or in a case that the second BWP set is the UL BWP set, each BWP in the second BWP set is the UL BWP.

In some embodiments of the disclosure, the method may further include that:

the terminal activates the second BWP in response to determining, based on the first configuration information, that each BWP in the second BWP set does not meet the predetermined rule and the first indication information is indication information of the second BWP in the second BWP set.

In a case that the second BWP set is the DL BWP set, the second BWP is the DL BWP; or in a case that the second BWP set is the UL BWP set, the second BWP is the UL BWP.

In some embodiments of the disclosure, each BWP in the second BWP set meets the predetermined rule, which may include:

each BWP in the second BWP set is consistent in frequency domain position and bandwidth size; or

a frequency domain range of each BWP, other than the second BWP, in the second BWP set is within a frequency domain range of the second BWP; or

an RF bandwidth capacity of the terminal is capable of simultaneously covering a frequency domain range of each BWP in the second BWP set.

In some embodiments of the disclosure, the method may further include that:

the terminal receives fourth configuration information from the network device, the fourth configuration information including third duration information corresponding to the second BWP; and

the terminal deactivates each BWP in the second BWP set in response to that an activated duration of the second BWP reaches a third duration.

In some embodiments of the disclosure, the method may further include that:

the terminal receives fifth configuration information from the network device, the fifth configuration information including fourth duration information corresponding to a third BWP in the second BWP set; and

the terminal deactivates the third BWP in response to that an activated duration of the third BWP reaches a fourth duration, the third BWP being different from the second BWP.

In some embodiments of the disclosure, the method may further include that:

a default BWP is activated in response to that each BWP in the second BWP set is deactivated.

A method for resource configuration according to a second aspect of the disclosure may include that:

a network device sends first control information to a terminal. The first control information may include first indication information, and the first indication information may be configured to determine at least two DL BWPs or the at least two UL BWPs to be activated, to enable the terminal to activate the at least two DL BWPs or the at least two UL BWPs according to the first control information.

In some embodiments of the disclosure, the method may further include that:

the network device sends first configuration information to the terminal. The first configuration information may include configuration information of at least one DL BWP set or at least one UL BWP set, the DL BWP set may include a plurality of DL BWPs, and the UL BWP set may include a plurality of UL BWPs.

In some embodiments of the disclosure, in response to that the first indication information is indication information of a first BWP set, the first indication information may be configured to enable the terminal to activate each BWP in the first BWP set.

In a case that the first BWP set is the DL BWP set, each BWP in the first BWP set may be the DL BWP; or in a case that the first BWP set is the UL BWP set, each BWP in the first BWP set may be the UL BWP.

In some embodiments of the disclosure, the method may further include that:

the network device sends second configuration information to the terminal, the second configuration information including first duration information corresponding to the first BWP set.

The first duration information may be configured to enable, in response to that an activated duration of each BWP in the first BWP set reaches a first duration, the terminal to deactivate each BWP in the first BWP set.

In some embodiments of the disclosure, the method may further include that:

the network device sends third configuration information to the terminal, the third configuration information including second duration information corresponding to a first BWP in the first BWP set.

The second duration information may be configured to enable, in response to that an activated duration of the first BWP reaches a second duration, the terminal to deactivate the first BWP.

In some embodiments of the disclosure, in response to it is determined, based on the first configuration information, that each BWP in a second BWP set meets a predetermined rule and the first indication information is indication information of a second BWP in the second BWP set, the first indication information may be configured to enable the terminal to activate each BWP in the second BWP set.

In a case that the second BWP set is the DL BWP set, each BWP in the second BWP set is the DL BWP; or in a case that the second BWP set is the UL BWP set, each BWP in the second BWP set is the UL BWP.

In some embodiments of the disclosure, in response to it is determined, based on the first configuration information, that each BWP in the second BWP set does not meet the predetermined rule and the first indication information is indication information of the second BWP in the second BWP set, the first indication information may be configured to enable the terminal to activate the second BWP.

In a case that the second BWP set is the DL BWP set, the second BWP may be the DL BWP; or in a case that the second BWP set is the UL BWP set, the second BWP may be the UL BWP.

In some embodiments of the disclosure, each BWP in the second BWP set meets the predetermined rule, which may include:

each BWP in the second BWP set is consistent in frequency domain position and bandwidth size; or

a frequency domain range of each BWP, other than the second BWP, in the second BWP set is within a frequency domain range of the second BWP; or

an RF bandwidth capacity of the terminal is capable of simultaneously covering a frequency domain range of each BWP in the second BWP set.

In some embodiments of the disclosure, the method may further include that:

the network device sends fourth configuration information to the terminal, the fourth configuration information including third duration information corresponding to the second BWP.

The third duration information may be configured to enable, in response to that an activated duration of the second BWP reaches a third duration, the terminal to deactivate each BWP in the second BWP set.

In some embodiments of the disclosure, the method may further include that:

the network device sends fifth configuration information to the terminal, the fifth configuration information including fourth duration information corresponding to a third BWP in the second BWP set.

The fourth duration information may be configured to enable, in response to that an activated duration of the third BWP reaches a fourth duration, the terminal to deactivate the third BWP, the third BWP being different from the second BWP.

A device for resource configuration according to a third aspect of the disclosure includes: a first receiving unit, and an activation unit.

The first receiving unit is configured to receive first control information from a network device, the first control information including first indication information, and the first indication information being configured to determine at least two DL BWPs or the at least two UL BWPs to be activated.

The activation unit is configured to activate the at least two DL BWPs or the at least two UL BWPs according to the first control information.

In some embodiments of the disclosure, the device may further include: a second receiving unit.

The second receiving unit is configured to receive first configuration information from the network device, the first configuration information including configuration information of at least one DL BWP set or at least one UL BWP set, the DL BWP set including a plurality of DL BWPs, and the UL BWP set including a plurality of UL BWPs.

In some embodiments of the disclosure, the activation unit may be further configured to enable, in response to that the first indication information is indication information of a first BWP set, a terminal to activate each BWP in the first BWP set.

In a case that the first BWP set is the DL BWP set, each BWP in the first BWP set may be the DL BWP; or in a case that the first BWP set is the UL BWP set, each BWP in the first BWP set may be the UL BWP.

In some embodiments of the disclosure, the device may further include: a third receiving unit and a deactivation unit.

The third receiving unit may be configured to receive second configuration information from the network device, the second configuration information including first duration information corresponding to the first BWP set.

The deactivation unit may be configured to deactivate each BWP in the first BWP set in response to that an activated duration of each BWP in the first BWP set reaches a first duration.

In some embodiments of the disclosure, the device may further include: a fourth receiving unit and the deactivation unit.

The fourth receiving unit may be configured to receive third configuration information from the network device, the third configuration information including second duration information corresponding to a first BWP in the first BWP set.

The deactivation unit may be configured to deactivate the first BWP in response to that an activated duration of the first BWP reaches a second duration.

In embodiments of the disclosure, the activation unit may be further configured to activate a default BWP in response to that each BWP in the first BWP set is deactivated.

In some embodiments of the disclosure, the activation unit may be configured to activate each BWP in the second BWP set in response to determining, based on the first configuration information, that each BWP in a second BWP set meets a predetermined rule and the first indication information is indication information of a second BWP in the second BWP set.

In a case that the second BWP set is the DL BWP set, each BWP in the second BWP set may be the DL BWP; or in a case that the second BWP set is the UL BWP set, each BWP in the second BWP set may be the UL BWP.

In some embodiments of the disclosure, the activation unit may be configured to activate the second BWP in response to determining, based on the first configuration information, that each BWP in the second BWP set does not meet the predetermined rule and the first indication information is the indication information of the second BWP in the second BWP set.

In a case that the second BWP set is the DL BWP set, the second BWP may be the DL BWP; or in a case that the second BWP set is the UL BWP set, the second BWP may be the UL BWP.

In some embodiments of the disclosure, each BWP in the second BWP set meets the predetermined rule, which may include:

each BWP in the second BWP set is consistent in frequency domain position and bandwidth size; or

a frequency domain range of each BWP, other than the second BWP, in the second BWP set is within a frequency domain range of the second BWP; or

an RF bandwidth capacity of the terminal is capable of simultaneously covering a frequency domain range of each BWP in the second BWP set.

In some embodiments of the disclosure, the device may further include: a fifth receiving unit and the deactivation unit.

The fifth receiving unit may be configured to receive fourth configuration information from the network device, the fourth configuration information including third duration information corresponding to the second BWP.

The deactivation unit may be configured to deactivate each BWP in the second BWP set in response to that an activated duration of the second BWP reaches a third duration.

In some embodiments of the disclosure, the device may further include: a sixth receiving unit and the deactivation unit.

The sixth receiving unit may be configured to receive fifth configuration information from the network device, the fifth configuration information including fourth duration information corresponding to a third BWP in the second BWP set.

The deactivation unit may be configured to deactivate the third BWP in response to that an activated duration of the third BWP reaches a fourth duration, the third BWP being different from the second BWP.

In embodiments of the disclosure, the activation unit may be further configured to activate a default BWP in response to that each BWP in the second BWP set is deactivated.

A device for resource configuration according to a fourth aspect of the disclosure includes a first sending unit.

The first sending unit is configured to send first control information to a terminal, the first control information including first indication information, and the first indication information being configured to determine at least two DL BWPs or the at least two UL BWPs to be activated, to enable the terminal to activate the at least two DL BWPs or the at least two UL BWPs according to the first control information.

In some embodiments of the disclosure, the device may further include a second sending unit.

The second sending unit may be configured to send first configuration information to the terminal, the first configuration information including configuration information of at least one DL BWP set or at least one UL BWP set, the DL BWP set including a plurality of DL BWPs, and the UL BWP set including a plurality of UL BWPs.

In some embodiments of the disclosure, in response to that the first indication information is indication information of a first BWP set, the first indication information may be configured to enable the terminal to activate each BWP in the first BWP set.

In a case that the first BWP set is the DL BWP set, each BWP in the first BWP set may be the DL BWP; or in a case that the first BWP set is the UL BWP set, each BWP in the first BWP set may be the UL BWP.

In some embodiments of the disclosure, the device may further include a third sending unit.

The third sending unit may be configured to send second configuration information to the terminal, the second configuration information including first duration information corresponding to the first BWP set.

The first duration information may be configured to enable, in response to that an activated duration of each BWP in the first BWP set reaches a first duration, the terminal to deactivate each BWP in the first BWP set.

In some embodiments of the disclosure, the device may further include a fourth sending unit.

The fourth sending unit may be configured to send third configuration information to the terminal, the third configuration information including second duration information corresponding to a first BWP in the first BWP set.

The second duration information may be configured to enable, in response to that an activated duration of the first BWP reaches a second duration, the terminal to deactivate the first BWP.

In some embodiments of the disclosure, in response to it is determined, based on the first configuration information, that each BWP in a second BWP set meets a predetermined rule and the first indication information is indication information of a second BWP in the second BWP set, the first indication information may be configured to enable the terminal to activate each BWP in the second BWP set.

In a case that the second BWP set is the DL BWP set, each BWP in the second BWP set may be the DL BWP; or in a case that the second BWP set is the UL BWP set, each BWP in the second BWP set may be the UL BWP.

In some embodiments of the disclosure, in response to it is determined, based on the first configuration information, that each BWP in the second BWP set does not meet the predetermined rule and the first indication information is indication information of the second BWP in the second BWP set, the first indication information may be configured to enable the terminal to activate the second BWP.

In a case that the second BWP set is the DL BWP set, the second BWP may be the DL BWP; or in a case that the second BWP set is the UL BWP set, the second BWP may be the UL BWP.

In some embodiments of the disclosure, each BWP in the second BWP set meets the predetermined rule, which may include:

each BWP in the second BWP set is consistent in frequency domain position and bandwidth size; or

a frequency domain range of each BWP, other than the second BWP, in the second BWP set is within a frequency domain range of the second BWP; or

an RF bandwidth capacity of the terminal is capable of simultaneously covering a frequency domain range of each BWP in the second BWP set.

In some embodiments of the disclosure, the device may further include a fifth sending unit.

The fifth sending unit may be configured to send fourth configuration information to the terminal, the fourth configuration information including third duration information corresponding to the second BWP.

The third duration information may be configured to enable, in response to that an activated duration of the second BWP reaches a third duration, the terminal to deactivate each BWP in the second BWP set.

In some embodiments of the disclosure, the device may further include a sixth sending unit.

The sixth sending unit may be configured to send fifth configuration information to the terminal, the fifth configuration information including fourth duration information corresponding to a third BWP in the second BWP set.

The fourth duration information may be configured to enable, in response to that an activated duration of the third BWP reaches a fourth duration, the terminal to deactivate the third BWP, the third BWP being different from the second BWP.

A computer storage medium provided by a fifth aspect of the disclosure has computer executable instructions stored thereon; and the computer executable instructions may implement, when being executed by a processor, the above-mentioned method for resource configuration.

In the technical solutions of some embodiments of the disclosure, a terminal may receive first control information from a network device, the first control information including first indication information, and the first indication information being configured to determine at least two DL BWPs or the at least two UL BWPs to be activated; and the terminal may activate the at least two DL BWPs or the at least two UL BWPs according to the first control information. By adopting the technical solutions of some embodiments of the disclosure, a concept of a BWP set is introduced; by configuring the BWP set, a plurality of BWPs in the BWP set may be activated at the same time; and with the utilization of the plurality of activated BWPs to transmit a signal, simultaneous transmission for multiple types of services can be flexibly supported, and the scheduling flexibility and the spectral utilization rate of a system can be improved.

The technical solutions in the embodiments of the disclosure may be freely combined without conflicts.

In some embodiments provided by the disclosure, it is to be understood that the disclosed method and intelligent device may be implemented in another manner. The device embodiment described above is only schematic, and for example, division of the units is only logic function division, and other division manners may be adopted during practical implementation. For example, multiple units or components may be combined or integrated into another system, or some characteristics may be neglected or not executed. In addition, coupling or direct coupling or communication connection between each displayed or discussed component may be indirect coupling or communication connection, implemented through some interfaces, of the device or the units, and may be electrical and mechanical or adopt other forms.

The units described as separate parts may or may not be physically separated, and parts displayed as units may or may not be physical units, and namely may be located in the same place, or may also be distributed to multiple network units. Part of all of the units may be selected according to a practical requirement to achieve the purposes of the solutions of the embodiments.

In addition, each functional unit in each embodiment of the disclosure may be integrated into a second processing unit, each unit may also serve as an independent unit and two or more than two units may also be integrated into a unit. The integrated unit may be implemented in a hardware form and may also be implemented in form of hardware and software functional unit.

The above is only the specific implementation of the disclosure and not intended to limit the scope of protection of the disclosure. Any variations or replacements apparent to those skilled in the art within the technical scope disclosed by the disclosure shall fall within the scope of protection of the disclosure.

1. A method for resource configuration, comprising:
receiving, by a terminal, first control information from a network device, where the first control information comprises first indication information, and the first indication information is configured to determine at least two downlink (DL) band width parts (BWPs) to be activated or at least two uplink (UL) BWPs to be activated; and
activating, by the terminal, the at least two DL BWPs or the at least two UL BWPs according to the first control information.

2. The method of claim 1, further comprising:
receiving, by the terminal, first configuration information from the network device, where the first configuration information comprises configuration information of at least one DL BWP set or at least one UL BWP set, the DL BWP set comprises a plurality of DL BWPs, and the UL BWP set comprises a plurality of UL BWPs.

3. The method of claim 2, wherein activating, by the terminal, the at least two DL BWPs or the at least two UL BWPs according to the first control information comprises:
in response to that the first indication information is indication information of a first BWP set, activating, by the terminal, each BWP in the first BWP;
wherein in a case that the first BWP set is the DL BWP set, each BWP in the first BWP set is the DL BWP; or in a case that the first BWP set is the UL BWP set, each BWP in the first BWP set is the UL BWP.

4. The method of claim 3, wherein
the method further comprises:
receiving, by the terminal, second configuration information from the network device, wherein the second configuration information comprises first duration information corresponding to the first BWP set; and
deactivating each BWP in the first BWP set in response to that an activated duration of each BWP in the first BWP set reaches a first duration;
or,
the method further comprises:
receiving, by the terminal, third configuration information from the network device, wherein the third configuration information comprises second duration information corresponding to a first BWP in the first BWP set; and
deactivating the first BWP in response to that an activated duration of the first BWP reaches a second duration.

5. The method of claim 4, further comprising:
activating a default BWP in response to that each BWP in the first BWP set is deactivated.

6. A method for resource configuration, comprising:
sending, by a network device, first control information to a terminal,
wherein the first control information comprises first indication information, and the first indication information is configured to determine at least two downlink (DL) band width parts (BWPs) to be activated or at least two uplink (UL) BWPs to be activated to enable the terminal to activate the at least two DL BWPs or the at least two UL BWPs according to the first control information.

7. The method of claim 6, further comprising:
sending, by the network device, first configuration information to the terminal,
wherein the first configuration information comprises configuration information of at least one DL BWP set or at least one UL BWP set, the DL BWP set comprises a plurality of DL BWPs, and the UL BWP set comprises a plurality of UL BWPs.

8. The method of claim 7, wherein in response to that the first indication information is indication information of a first BWP set, the first indication information is configured to enable the terminal to activate each BWP in the first BWP set;
in a case that the first BWP set is the DL BWP set, each BWP in the first BWP set is the DL BWP; or in a case that the first BWP set is the UL BWP set, each BWP in the first BWP set is the UL BWP.

9. The method of claim 8, wherein
the method further comprises:
sending, by the network device, second configuration information to the terminal,
wherein the second configuration information comprises first duration information corresponding to the first BWP set; and the first duration information is configured to enable the terminal to deactivate each BWP in the first BWP set, in response to that an activated duration of each BWP in the first BWP set reaches a first duration;
or,
the method further comprises:
sending, by the network device, third configuration information to the terminal,
wherein the third configuration information comprises second duration information corresponding to a first BWP in the first BWP set; and the second duration information is configured to enable the terminal to deactivate the first BWP, in response to that an activated duration of the first BWP reaches a second duration.

10. A device for resource configuration, comprising:
a transmission device, configured to receive first control information from a network device, where the first control information comprises first indication information, and the first indication information is configured to determine at least two downlink (DL) band width parts (BWPs) to be activated or at least two uplink (UL) BWPs to be activated; and
a processor, connected to the transmission device and configured to activate the at least two DL BWPs or the at least two UL BWPs according to the first control information.

11. The device of claim 10, wherein the transmission device is further configured to:
receive first configuration information from the network device, wherein the first configuration information comprises configuration information of at least one DL BWP set or at least one UL BWP set, the DL BWP set comprising a plurality of DL BWPs, and the UL BWP set comprising a plurality of UL BWPs.

12. The device of claim 11, wherein the processor is configured to:
activate each BWP in the second BWP set in response to determining, based on the first configuration information, that each BWP in a second BWP set meets a predetermined rule and the first indication information is indication information of a second BWP in the second BWP set, wherein in a case that the second BWP set is the DL BWP set, the each BWP in the second BWP set is the DL BWP; or in a case that the second BWP set is the UL BWP set, the each BWP in the second BWP set is the UL BWP;
or,
activate the second BWP in response to determining, based on the first configuration information, that each BWP in the second BWP set does not meet the predetermined rule and the first indication information is the indication information of the second BWP in the second BWP set, wherein in a case that the second BWP set is the DL BWP set, the second BWP is the DL BWP; or in a case that the second BWP set is the UL BWP set, the second BWP is the UL BWP.

13. The device of claim 12, wherein the each BWP in the second BWP set meets the predetermined rule, which comprises:
the each BWP in the second BWP set is consistent in frequency domain position and bandwidth size; or
a frequency domain range of the each BWP, other than the second BWP, in the second BWP set is within a frequency domain range of the second BWP; or
a radio frequency (RF) bandwidth capacity of the terminal is capable of simultaneously covering a frequency domain range of the each BWP in the second BWP set.

14. The device of claim 12, wherein
the processor is further configured to:
control the transmission device to receive fourth configuration information from the network device, wherein the fourth configuration information comprises third duration information corresponding to the second BWP; and
deactivate the each BWP in the second BWP set in response to that an activated duration of the second BWP reaches a third duration;
or,
the processor is further configured to:
control the transmission device to receive fifth configuration information from the network device, wherein the fifth configuration information comprises fourth duration information corresponding to a third BWP in the second BWP set; and
deactivate the third BWP in response to that an activated duration of the third BWP reaches a fourth duration, the third BWP being different from the second BWP.

15. The device of claim 14, wherein the processor is further configured to activate a default BWP in response to that the each BWP in the second BWP set is deactivated.

16. A device for resource configuration, comprising:
a transmission device, configured to send first control information to a terminal, and
a processor, connected to the transmission device and configured to control the transmission device to receive and send information;
wherein the first control information comprises first indication information, and the first indication information is configured to determine at least two downlink (DL) band width parts (BWPs) to be activated or at least two uplink (UL) BWPs to be activated to enable the terminal to activate the at least two DL BWPs or the at least two UL BWPs according to the first control information.

17. The device of claim 16, wherein the transmission device is further configured to:
send first configuration information to the terminal,
wherein the first configuration information comprises configuration information of at least one DL BWP set or at least one UL BWP set, the DL BWP set comprises a plurality of DL BWPs, and the UL BWP set comprises a plurality of UL BWPs.

18. The device of claim 17, wherein in response to it is determined, based on the first configuration information, that each BWP in a second BWP set meets a predetermined rule and the first indication information is indication information of a second BWP in the second BWP set, the first indication information is configured to enable the terminal to activate each BWP in the second BWP set;
wherein in a case that the second BWP set is the DL BWP set, the each BWP in the second BWP set is the DL BWP; or in a case that the second BWP set is the UL BWP set, the each BWP in the second BWP set is the UL BWP.

19. The device of claim 17, wherein in response to it is determined, based on the first configuration information, that each BWP in the second BWP set does not meet the predetermined rule and the first indication information is the indication information of the second BWP in the second BWP set, the first indication information is configured to enable the terminal to activate the second BWP;
wherein in a case that the second BWP set is the DL BWP set, the second BWP is the DL BWP; or in a case that the second BWP set is the UL BWP set, the second BWP is the UL BWP.

20. The device of claim 18, wherein the each BWP in the second BWP set meets the predetermined rule, which comprises:
the each BWP in the second BWP set is consistent in frequency domain position and bandwidth size; or
a frequency domain range of the each BWP, other than the second BWP, in the second BWP set is within a frequency domain range of the second BWP; or
a radio frequency (RF) bandwidth capacity of the terminal is capable of simultaneously covering a frequency domain range of each BWP in the second BWP set.

21. The device of claim 18, wherein the transmission device is further configured to:
send fourth configuration information to the terminal, wherein the fourth configuration information comprises third duration information corresponding to the second BWP, wherein the third duration information is configured to enable the terminal to deactivate each BWP in the second BWP set, in response to that an activated duration of the second BWP reaches a third duration; or
send fifth configuration information to the terminal, wherein the fifth configuration information comprises fourth duration information corresponding to a third BWP in the second BWP set, wherein the fourth duration information is configured to enable, in response to that an activated duration of the third BWP reaches a fourth duration, the terminal to deactivate the third BWP, the third BWP being different from the second BWP.
